(19) United States
(12) Patent Application Publication
(10) Pub. No.: US 2022/0032522 A1
(43) Pub. Date: Feb. 3, 2022

(54) SYSTEM FOR CONTROLLING A SHUTTER OF A PLASTIC MATERIAL INJECTION SYSTEM

(71) Applicant: RUNIPSYS EUROPE, MERY (FR)

(72) Inventor: Eric DERICHE, MERY (FR)

(73) Assignee: RUNIPSYS EUROPE, MERY (FR)

(21) Appl. No.: 17/297,764

(22) PCT Filed: Nov. 27, 2019
(86) PCT No.: PCT/FR2019/052813

§ 371 Date: May 27, 2021

(30) Foreign Application Priority Data
Nov. 28, 2018 (FR) 1872029

(51) Int. Cl. B29C 45/76; B29C 45/23

(52) U.S. Cl. CPC B29C 45/7613; B29C 45/23; B29C 2945/76083; B29C 2945/7621; B29C 2945/76859; B29C 2945/7604; B29C 2945/76254; B29C 2945/76568; B29C 2945/76688; B29C 2945/76006

(57) ABSTRACT

The invention relates to a system for controlling a shutter (110) slidably arranged in a plastic material injection nozzle (11), comprising a rotary electric motor (M) and a mechanism adapted to couple said motor (M) to the shutter to slidably drive it between a closing position of the nozzle and a maximum opening position of the nozzle, characterised in that said mechanism comprises:
an eccentric (21) integral with an output shaft (20) of the motor so as to be rotationally driven by said output shaft, comprising a crank pin (22) parallel to the output shaft but non-coaxial with said shaft (20),
a slide (23) adapted to be made integral with one end of the shutter (110), and
a connecting rod (25), a first end of which is articulated on the crank pin (22) of the eccentric (21) and a second end is articulated on an axis (25b) of the slide (23) such that the rotation of the eccentric causes sliding of the oscillating shutter between the closing position and the maximum opening position.

### FIELD OF THE INVENTION

The present invention relates to a system for controlling a shutter slidably arranged in a plastic material injection nozzle.

### TECHNOLOGICAL BACKGROUND OF THE INVENTION

A “hot runner” type injection system normally comprises:
a distributor delimiting a plastic material distribution channel and comprising a thermoplastic material output, said distributor comprising means making it possible to maintain its temperature, and consequently that of the material transiting in the distribution channel, at a temperature greater than the limit temperature for the material to pass to the fluid state,
an injection nozzle defining at least one portion of a transit passage, the input of which is in fluidic connection with the output of the distribution channel, and the output of which substantially opens into the moulding cavity,
a shutter mounted to longitudinally slide inside the transit passage and occupying alternately a closing position and an opening position thereof,
control means to make the shutter alternately slide between the closing position and the opening position.

These control means may comprise a hydraulic cylinder, a pneumatic cylinder or an electric actuator.

The control of the opening and the closing of the shutter has a particular importance for the quality of the parts formed in the moulding cavity, notably in the case of sequential injection, that is to say when the moulding cavity is supplied by several injection nozzles, the opening and closing are temporally offset.

Compared to hydraulic and pneumatic technologies, an electric actuator has the advantage of enabling more precise and reproducible control of the position of the shutter and consequently the flow of material from the distributor to the moulding cavity.

Furthermore, such an actuator is also cleaner and has a longer lifetime due to the absence of oil.

In general, the actuator comprises a rotary electric motor, which thus has a rotationally driven output shaft. Different mechanisms have already been described for coupling the output shaft to the shutter and to convert rotation of the output shaft into translation of the shutter.

The document U.S. Pat. No. 6,294,122 thus describes a system based on a screw-nut type mechanism which is a known means for converting rotation into translation. According to an embodiment, the output shaft is coaxial with the shutter and fixed directly to the element of the screw-nut mechanism which is translationally moveable. However, since the actuator is arranged on the rear face of the distributor (that is to say the face opposite to the moulding cavity), such a solution is particularly bulky and substantially increases the thickness of the mould. According to another embodiment, the output shaft is perpendicular to the shutter and to the screw-nut mechanism, and coupled to the screw by a gearing. However, even if the bulk in the sense of the thickness may be reduced thanks to this arrangement of the actuator, the gearing is subjected to considerable wear and problems of friction, liable to reduce the precision of the control of the position of the shutter.

The document EP 2 679 374 aims to reduce the bulk in thickness of the hot runner, by arranging the actuator on one side of the distributor, with its output shaft parallel to the shutter. A mechanism including a ball screw makes it possible to convert the rotational movement of the output shaft of the actuator into a translational movement, which makes it possible to actuate a rocker coupled to the shutter. However, this mechanism is particularly complex and, even though part of the actuator is offset on one side of the distributor, it remains bulky.

The document EP 2 918 389 for its part describes a system wherein the electric actuator is arranged in a base plate situated on the rear face of the mould, the output shaft and the screw-nut mechanism being arranged parallel with one another and perpendicularly to the shutter, the shutter being coupled to the element of the screw-nut system translationally moveable by an oscillating lever.

Finally, the document U.S. Pat. No. 6,086,357 describes a system wherein an eccentric cam is rotationally driven by the output shaft of the motor with respect to an axis perpendicular to the shutter, the rotation of the cam causing an alternating translational movement of the shutter. However, such a system is subjected to considerable thermal expansions, which are liable to reduce the closing precision.

### BRIEF DESCRIPTION OF THE INVENTION

An aim of the invention is to design an injection system wherein the shutter is controlled by an electric actuator, of which the bulk in thickness is reduced compared to known solutions.

In accordance with the invention, a system is proposed for controlling a shutter slidably arranged in a plastic material injection nozzle, comprising a rotary electric motor and a mechanism adapted to couple said motor to the shutter to slidably drive it between a closing position of the nozzle and a maximum opening position of the nozzle, characterised in that said mechanism comprises:
an eccentric integral with an output shaft of the motor so as to be rotationally driven by said output shaft, comprising a crank pin parallel to the output shaft but non-coaxial with said shaft,
a slide adapted to be made integral with one end of the shutter, and
a connecting rod, a first end of which is articulated on the crank pin of the eccentric and a second end is articulated on an axis of the slide such that the rotation of the eccentric causes sliding of the oscillating shutter between the closing position and the maximum opening position.

This system has several advantages.

On the one hand, its bulk is limited. In particular, the electric actuator may be arranged in a housing of the base plate normally provided for a hydraulic or pneumatic cylinder. A change of actuating energy may thus be carried out easily.

On the other hand, the actuating efficiency is improved thanks to the direct conversion of rotation of the output shaft into translation of the shutter.

Furthermore, compared to a lever system, the system according to the invention consumes little energy in the two extreme positions of the shutter (complete opening or complete closing) because these two positions are stable equilibrium positions of the mechanism.

According to other advantageous characteristics of the invention, potentially combined:
the axis of rotation of the output shaft of the electric motor is perpendicular to the sliding axis of the shutter;
the system comprises a guide wherein said slide is slidably arranged;
according to an embodiment, the end of the shutter comprises a radial collar and the slide comprises a slot adapted to receive said collar, said slot extending in a plane perpendicular to the sliding direction (X) of the shutter;
according to another embodiment, the slide comprises a slot and a washer able to be displaced radially in said slot, and the end of the shutter is integral with said washer.

Another subject matter of the invention relates to a plastic material injection system, comprising:
a distributor comprising at least one injection nozzle,
at least one shutter slidably mounted in the injection nozzle between a closing position of the nozzle and a maximum opening position of the nozzle,
a base plate comprising a housing wherein is arranged the shutter control system such as described above,
a electronic board for controlling the actuator, comprising at least two components among:
   a component adapted to regulate the opening or the closing of the shutter at a first constant speed,
   a component adapted to regulate the opening or the closing of the shutter at a second constant speed, greater than the first speed,
   a component adapted to selectively block the rotation of the motor,
a sequential control unit comprising at least two control paths, configured to send selectively an electrical control signal to the electronic board via one of said control paths in such a way that:
under the effect of a first signal sent via a first control path, one of the components is activated,
under the effect of a second signal sent via a second control path, another component is activated.

According to an embodiment, the actuator and/or the shutter is provided with a position sensor and the sequential control unit is configured to control the transmission of control signals as a function of measurements supplied by said position sensor.

Furthermore, the sequential control unit may be configured to further take into account at least one of the following data: a time of the injection method, a position of a sensor, a pressure or a temperature in the injection tooling, a signal of the injection moulding machine.

According to an embodiment, the sequential control unit is configured to send an electrical control signal in the form of a direct current.

In an alternative manner, the sequential control unit is configured to send an electrical control signal in the form of an alternating current.

The invention finally relates to a method for modifying a plastic material injection system, wherein said system comprises:
a distributor comprising at least one injection nozzle,
at least one shutter slidably mounted in the injection nozzle between a closing position of the nozzle and a maximum opening position of the nozzle,
a base plate comprising a housing wherein is arranged a hydraulic or pneumatic cylinder for controlling the shutter,
   said method being characterised in that it comprises the removal of the cylinder and the replacement of said cylinder in the housing by a control system such as described above.

### BRIEF DESCRIPTION OF THE DRAWINGS

Other characteristics and advantages of the invention will become clear from the detailed description that follows, with reference to the appended drawings wherein:

FIG. 1 is a partial perspective view of an injection system in the absence of the actuator,

FIG. 2 is a view of a control system according to an embodiment, at a first assembly stage,

FIG. 3 is a view of a control system according to an embodiment, at a second assembly stage,

FIG. 4 is a view of a control system according to an embodiment, at a third assembly stage,

FIG. 5 shows comparative diagrams of a control system according to the invention and a control system according to the prior art,

FIG. 6 shows other comparative diagrams of a control system according to the invention and a control system according to the prior art,

FIG. 7 is a partial perspective view of an injection system with a hydraulic cylinder according to an embodiment of the invention,

FIG. 8 is a partial perspective view of an injection system with an electric actuator according to an embodiment of the invention, implementing lateral coupling of the shutter and the slide,

FIG. 9 is a partial perspective view of an injection system with an electric actuator according to another embodiment of the invention, implementing axial coupling of the shutter and the slide,

FIG. 10 is a block diagram of a system for controlling the shutter according to an implementation configuration,

FIG. 11 is a block diagram of a system for controlling the shutter according to another implementation configuration,

FIG. 12 is a graph of the travel of the shutter as a function of time in the course of two opening-closing cycles of the shutter, capable of being obtained with one configuration of the control system,

FIG. 13 is a graph of the travel of the shutter as a function of time in the course of an opening-closing cycle of the shutter, capable of being obtained with another configuration of the control system.

Identical reference signs from one figure to the other designate identical elements or elements fulfilling the same function.

### DETAILED DESCRIPTION OF EMBODIMENTS OF THE INVENTION

In a manner known per se, the injection system comprises a shutter slidably arranged in a plastic material injection nozzle.

The nozzle and the shutter are known per se and will not be described in detail. As regards the general architecture of the injection system, those skilled in the art may refer to the description provided in the document EP 1 196 274 which is applicable to the present invention, apart from that which concerns the actuation of the shutter (the document EP 1 196 274 describing a hydraulic actuation).

Generally speaking, the system (actuator) for controlling the shutter comprises a rotary electric motor and a mechanism linking the output shaft of the motor to said shutter to slidably drive it between a closing position of the nozzle and a maximum opening position of the nozzle.

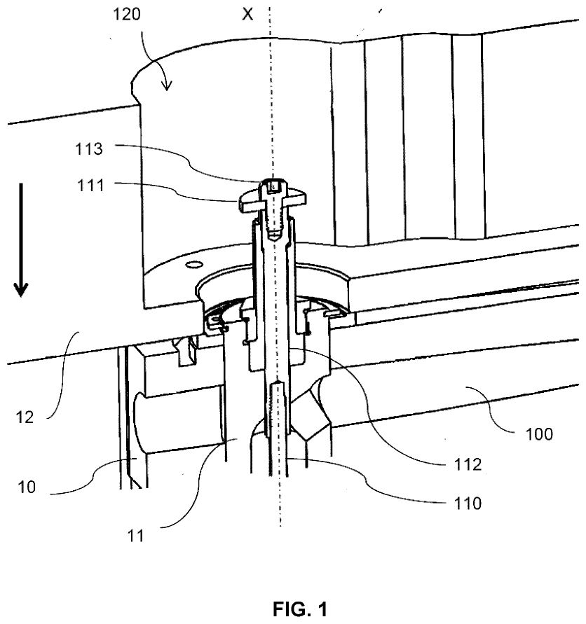

FIG. 1 is a partial perspective view of the injection system in the absence of the actuator.

The injection system comprises a mould (not illustrated) having a moulding cavity. In a conventional manner, the terms “rear” and “front” are understood in the present text with respect to the direction of injection of the plastic material into the moulding cavity, a rear region being upstream of a front region with respect to this injection direction. This direction is represented by the arrow on the left of FIG. 1.

The mould is provided with at least one injection well opening into the moulding cavity and intended to receive a respective nozzle, the nozzle and the well being coaxial.

Each nozzle 11 is integral with a distributor 10 which comprises a plastic material distribution channel 100 opening into a transit passage of the nozzle 11. A single nozzle is represented in FIG. 1 but, preferably, the distributor has several injection nozzles spread out on the surface of the mould, making it possible to inject plastic material in a sequential manner into the moulding cavity. Such sequential injection aims to control the flow of plastic material within the mould cavity and to reduce or even eliminate visual defects linked notably to the meeting of two flows.

The distributor 10 is mounted on a base plate 12 fixed on the rear face of the mould in such a way that the distributor can undergo thermal expansion with respect to the base plate and to the mould without affecting the centring of the nozzle with respect to the injection well.

A shutter 110 is slidably arranged in the nozzle 11 between a closing position preventing the passage of plastic material in the transit passage up to the moulding cavity, and an opening position wherein the flow of plastic material can flow without restriction from the distribution channel 100 into the transit passage. The shutter has a general shape of revolution around a longitudinal axis X.

The shutter 110 has, at its rear end, a collar 111 extending radially with respect to the longitudinal axis X.

In the embodiment illustrated, the shutter 110 is made integral (by screwing or any other means) with the front end of a rod 112 coaxial with the shutter. At the rear end of said rod is fixed an annular washer forming the collar 111, said washer being made integral with the rod by a bolt 113 or any other means. Alternatively, the collar could form an integral part of the rod.

The rod 112 makes it possible to guide the sliding of the shutter in the transit passage of the nozzle.

The base plate 12 comprises, in the rear part thereof, a housing 120 intended to receive the actuator. As will be described hereafter, the actuator is coupled to the rear part of the shutter 110/rod 112 assembly.

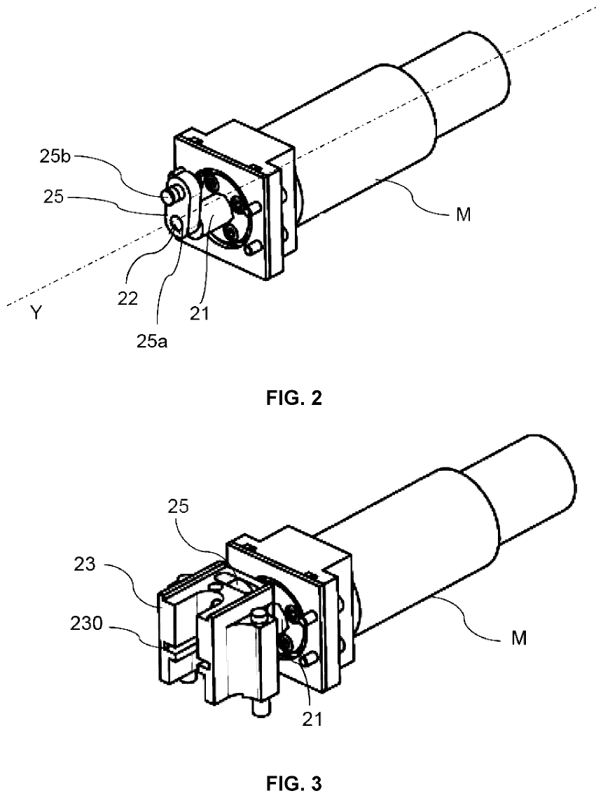

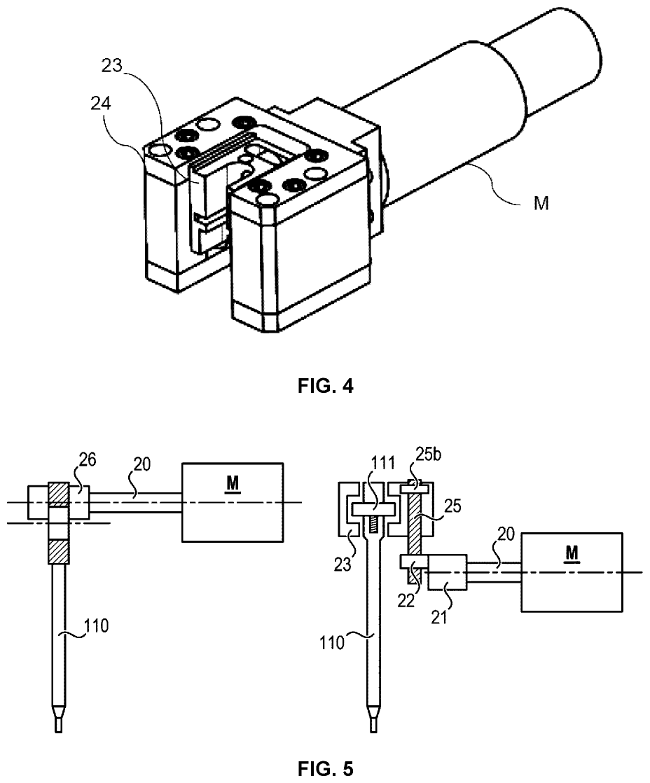

FIGS. 2 to 4 are views of said actuator at different assembly stages.

The actuator 2 comprises an electric motor M. Said motor is advantageously associated with a reducer (not represented) to form a gear motor. In the remainder of the text, the term “motor” comprises a gear motor.

The motor comprises an output shaft (designated by the reference 20 in FIG. 5) rotationally moveable around an axis Y which is perpendicular to the axis X of the shutter. The speed of rotation of the shaft may be adjusted as a function of an electrical control signal of the motor.

The mechanism of transmission of movement comprises an eccentric 21 which is rigidly integral with the output shaft of the motor and is thus adapted to be rotationally driven by said shaft. The eccentric 21 comprises a crank pin 22 parallel to the output shaft of the motor but non-coaxial therewith.

A slide 23 is configured to be made integral with the rear end of the shutter.

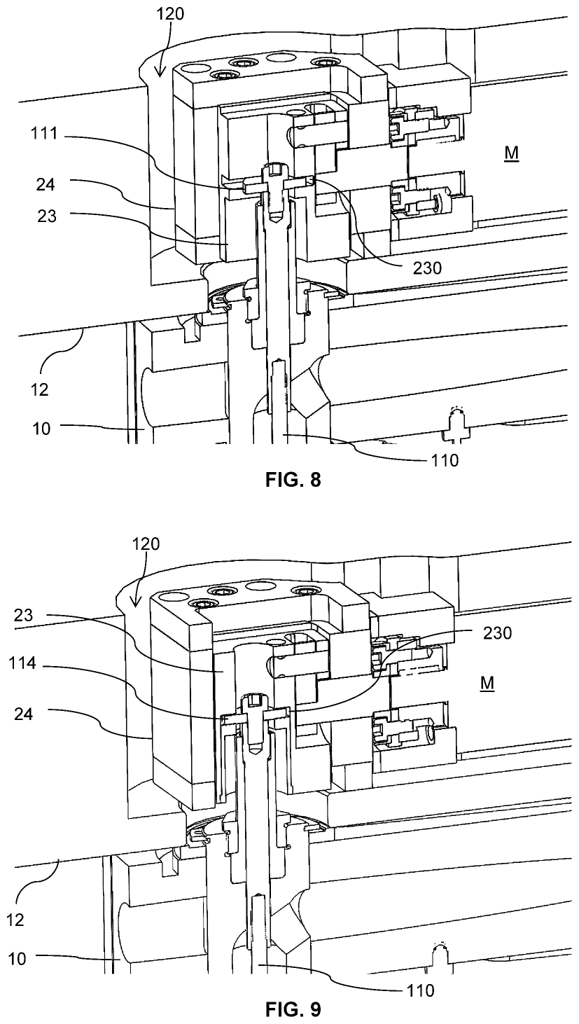

According to an embodiment, also illustrated in FIG. 8, the making integral of the shutter vis-à-vis the slide is done laterally, by engagement of the collar 111 in a slot 230 arranged in the slide, said slot extending in a plane perpendicular to the sliding direction of the shutter. An advantage of such a link is that it allows sliding of the collar in the slot in the aforementioned plane, or even in a direction perpendicular to said plane, thus making it possible to absorb potential thermal expansions between the distributor and the base plate.

Alternatively, illustrated in FIG. 9, the making integral of the shutter vis-à-vis the slide is done axially, the rod of the shutter being inserted and maintained in a washer 114 coaxial with said rod and trapped in a slot 230 of the slide. The washer 114 is able to be displaced radially in the slot in order to absorb potential thermal expansions between the distributor and the base plate.

A connecting rod 25 is arranged between the eccentric 21 and the slide 23. The connecting rod comprises an orifice 25a adapted to engage on the crank pin 22 of the eccentric and enable the rotational driving of the connecting rod, and an articulation axis 25b perpendicular to the sliding axis of the shutter. The slide is mounted on said articulation axis by a pivot link.

The slide 23 is itself slidably mounted in a guide 24 extending along the axis X, such that a rotational movement of the connecting rod causes a translational movement of the slide in the guide, the slide translationally driving the shutter along the axis X.

This movement is cyclic, that is to say that the slide is alternately displaced from front to back (direction of opening of the nozzle) and from back to front (direction of closing of the nozzle). It is thus not necessary to reverse the direction of rotation of the output shaft of the electric motor to reverse the direction of displacement of the shutter. This oscillation of the shutter makes it possible, during the phase of maintaining the injection cycle, to force diffusion of pressure lines within the plastic material and to avoid the interface between pressure lines becoming set along a determined line which would cause a visible defect.

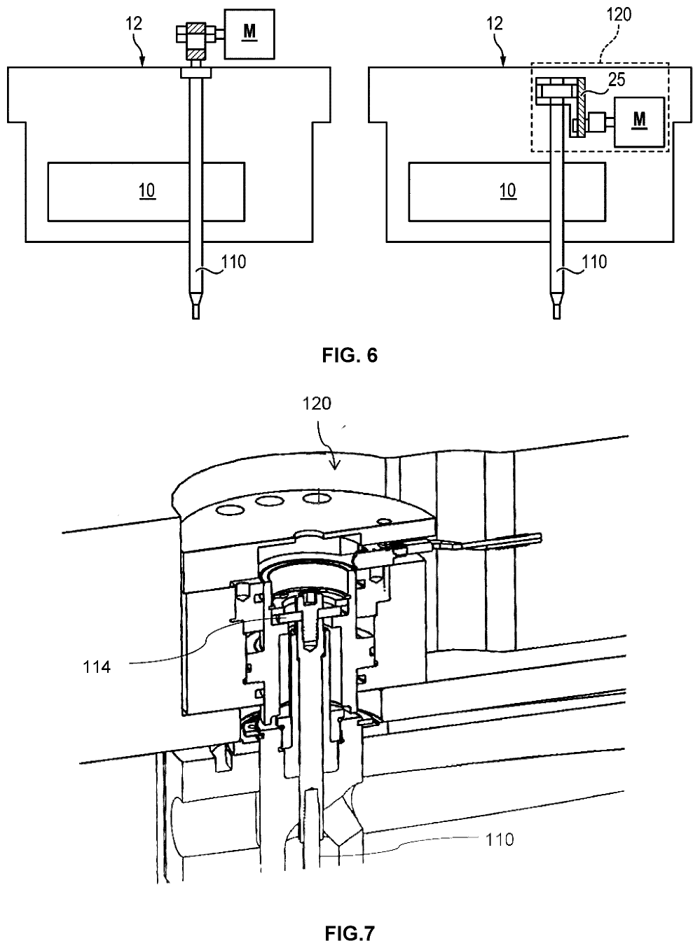

Another advantage of the invention is its compactness. FIGS. 5 and 6 thus highlight the compactness of the system according to the invention (on the right) compared to a system with eccentric cam of the type described in the document U.S. Pat. No. 6,086,357. FIG. 5 represents the actuators with their respective shutters. The coupling of the slide to the output shaft of the motor by means of the eccentric 21/crank pin 22/connecting rod 25 assembly makes it possible to reduce the bulk of the actuator along the axis X with respect to the actuator according to the prior art. This results in a difference in the positioning of the actuator with respect to the base plate 12, as illustrated in FIG. 6. Thus, the actuator according to the invention may be arranged in a housing 120 formed inside the base plate; conversely, the actuator according to the prior art has to be arranged at the rear of the base plate, to the detriment of the thickness of the mould. Furthermore, as described above, the coupling of the shutter with the slide by engagement of the collar 111 in the slot 230 inside of which it may slide makes it possible to compensate differences in thermal expansion between the nozzle and the motor. Such management of differences in thermal expansion cannot be carried out in the actuator with eccentric cam according to the prior art.

An additional advantage of the invention is that the electric actuator that has been described is interchangeable with a hydraulic or pneumatic cylinder. Indeed, the electric actuator may be installed in the housing 120 initially provided in the base plate for a hydraulic or pneumatic cylinder, and the link up of the shutter with the actuator is identical to that provided for a cylinder.

It is thus easy to modify an injection system initially comprising a hydraulic or pneumatic cylinder to switch to electric actuation of the shutter.

FIG. 7 thus illustrates the injection system of FIG. 1 with a hydraulic cylinder. The piston of said cylinder comprises a slot wherein is housed a washer 114 able to be displaced radially in said slot to absorb potential thermal expansions between the distributor and the base plate. The rod of the shutter 110 is mounted on said washer for example by means of a screw.

FIG. 8 illustrates the injection system of FIG. 1 with an electric actuator such as described above with reference to FIGS. 2 to 4. The electric motor M is arranged in the same housing with the output shaft 20 perpendicular to the axis X of the shutter. The shutter is radially coupled to the slide 23 by engagement of the collar 111 in the slot 230. No adaptation of the housing 120 or the shutter 110 is necessary to connect the shutter to the electric actuator.

FIG. 9 illustrates an alternative of the injection system of FIG. 8, wherein, as explained above, the coupling between the shutter and the slide is axial. It will be noted that this coupling is identical to that between the shutter and the piston of the hydraulic cylinder of FIG. 7. Thus, as in the embodiment with radial coupling, no adaptation of the housing 120 or the shutter 110 is necessary to connect the shutter to the electric actuator.

Such a replacement of a hydraulic or pneumatic cylinder by an electric actuator has several advantages. On the one hand, the electric actuator enables greater complexity of the law of positioning the shutter in the course of an injection cycle. On the other hand, the electric actuator procures greater precision and has more reproducibility of positioning and speed of displacement of the shutter. Finally, the electric motor is more reliable, cleaner and less subject to wear than a hydraulic or pneumatic cylinder. A change of actuating technology on an existing injection system is thus entirely relevant.

The displacement speed of the shutter is adjusted by an electrical signal transmitted by a component of an electronic control board to the motor. Similarly, a blocking of the travel of the shutter may be obtained by a specific electrical signal transmitted by a component of the electronic control board to the motor.

A fine adjustment of the travel of the shutter is thus obtained, capable of substantially improving the quality of the injected parts. This adjustment is advantageously specific to each actuator-shutter assembly comprised in the injection system, in order to optimise the control of the flow of plastic material inside the cavity.

The electronic control board is electrically connected to a sequential control unit. Such a control unit, also known by the term sequencer, is commercially available according to different models and does not require particular adaptation to be able to be used in the present invention.

The sequential control unit comprises at least two control paths, each electrically connected to a component of the control board.

The sequential control unit is configured to send selectively an electrical control signal via one and/or the other of said control paths to the components of the electronic board in such a way that:
under the effect of a first signal sent via the first path, the output shaft is driven at a first speed of rotation, resulting in a first speed of translation of the shutter,
under the effect of a second signal sent via the second path, the output shaft is driven at a second speed of rotation different from the first or is blocked, which results respectively in a second speed of translation of the shutter or in the blockage thereof.

In so far as the movement described by the axis of the connecting rod on which is articulated the slide is sinusoidal, there is no proportionality between the speed of rotation of the output shaft and the speed of translation of the shutter. The speed of rotation of the output shaft of the motor must thus be controlled continuously as a function of the angular position of the connecting rod so that the translation speed of the shutter is the desired speed.

Each control signal may be transmitted in the form of a direct or an alternating electric current.

In a particularly advantageous manner, the actuator or the shutter is provided with a position sensor coupled to the sequential control unit and the sequential control unit controls the transmission of control signals as a function of measurements supplied by said position sensor. The use of such a sensor is known per se and does not need to be described in greater detail in the present text. The fact of generating control signals from measurement data of such a position sensor enables more precise control of the opening-closing sequence than from purely temporal sequencing.

Furthermore, the sequential control unit may take into account one at least of the following data—combined with the data of the aforementioned position sensor—for the transmission of the control signals: a time, the position of a sensor (for example: the position of the extrusion screw), a pressure or a temperature in the tooling (injection mould or hot runner), signal of the injection moulding machine (for example: top injection, top maintain), etc. These data are commonly recorded during the implementation of the thermoplastic injection method, and the injection moulding machine and the injection tooling are equipped with appropriate sensors, coupled to an acquisition box. The exploitation of these data thus does not require acquisition means developed specifically for the invention. Those skilled in the art are capable to processing one or more of said signals and deducing therefrom a programming of each opening-closing sequence of the shutter.

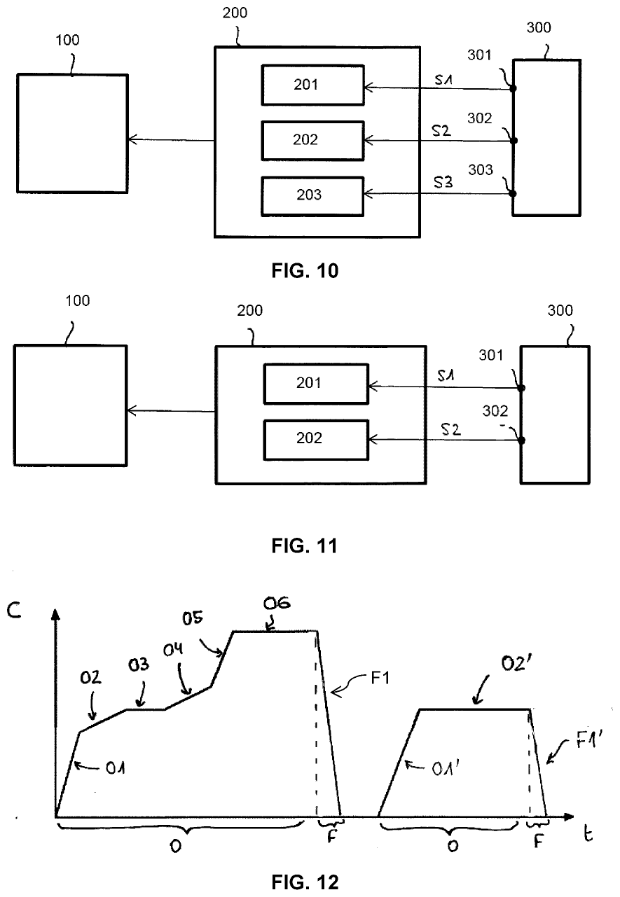

FIG. 10 is a block diagram of the system for controlling the shutter according to an embodiment.

The actuator is designated by the reference 100. The shutter is not represented in this figure.

The electronic board for controlling 200 the actuator comprises three components 201, 202, 203 of which one is a component for regulating the speed of the shutter adjusted to a first constant speed (called slow speed), another is a component for regulating the speed of the shutter adjusted to a second constant speed (called rapid speed), greater than the first speed, and yet another is a component for blocking the opening travel of the shutter.

The sequential control unit is designated by the reference 300. It comprises three output paths 301, 302, 303, each connected to a respective component 201, 202, 203 of the electronic control board, making it possible to send thereto a respective control signal S1, S2, S3.

FIG. 11 is a block diagram of the shutter control system in a simplified embodiment wherein the electronic control board 200 only comprises two components 201, 202. In this case, only two paths 301, 302 of the sequential control unit 300 are used.

Whatever the form of implementation, the components of the electronic board are programmed beforehand according to techniques known per se.

As indicated above, the control unit comprises at least two control paths, each electrically connected to one of the components of the electronic board.

Thus, the sending of a control signal via a first control path to one of the components (for example, a component for adjusting the speed of rotation of the output shaft of the motor) triggers the operation of the motor in such a way as to obtain the desired translation speed.

A control signal sent via a second control path to another component (for example, the component for blocking the rotation of the shaft) has the effect of stopping the motor to immobilise the shutter.

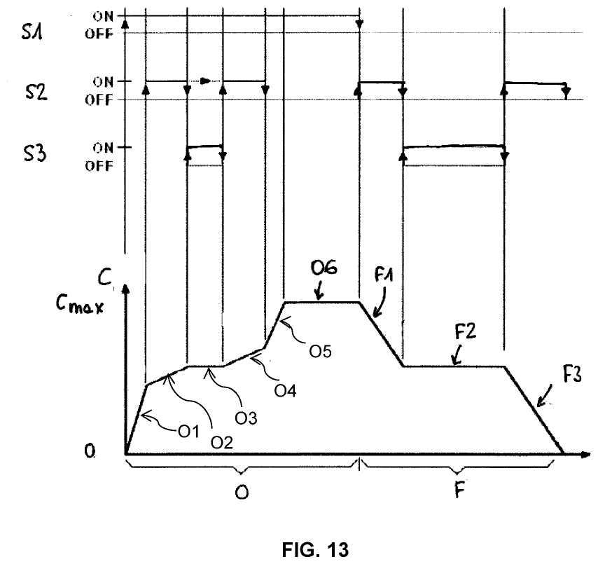

It is thus possible to obtain different graphs of the travel of the shutter in the course of an opening-closing sequence, examples of which that are in no way limiting are illustrated in FIGS. 12 and 13.

FIG. 12 illustrates a first exemplary graph of travel of the shutter over time capable of being obtained with a control system according to the invention.

Zero travel corresponds to total closing of the shutter.

A first step O1 of the opening phase O is carried out at rapid speed.

A second step O2 of the opening phase O is carried out at slow speed.

A third step O3 of the opening phase O is carried out with the shutter blocked.

A fourth step O4 of the opening phase O is carried out at slow speed.

A fifth step O5 of the opening phase O is carried out at rapid speed.

In a sixth step O6 of the opening phase O, the maximum opening travel of the shutter being reached, said shutter is blocked.

The closing step F1 is for its part at rapid speed.

A second opening-closing sequence comprises a first step O1′ at rapid speed, a second step O2′ with the shutter blocked, and a closing step at rapid speed F1′.

FIG. 13 illustrates a second exemplary graph of the travel C of the shutter in the course of an opening-closing cycle capable of being obtained with a control system according to the invention.

The signals S1, S2, S3 of each of the three paths of the sequential control unit respectively connected to the components 201 (regulation at rapid speed), 202 (regulation at slow speed), 203 (blocking) of the electronic control board have either zero amplitude (OFF), or an amplitude of a determined value (ON). The OFF state corresponds to an absence of power supply to the considered component.

In a first step O1 of the opening phase O, the signal S1 is in the ON state whereas the signals S2 and S3 are in the OFF state. The shutter begins its opening travel at the rapid speed.

In a second step O2 of the opening phase O, the signal S1 is still in the ON state and the signal S2 switches to the ON state, the signal S3 remaining in the OFF state. The travel of the shutter slows down to the slow speed.

In a third step O3 of the opening phase O, the signal S1 is still in the ON state and the signal S3 switches to the ON state, the signal S2 switching to the OFF state or not. The travel of the shutter is then blocked.

In a fourth step O4 of the opening phase O, the signal S1 is still in the ON state and the signal S2 switches to the ON state, the signal S3 switching to the OFF state. The travel of the shutter then restarts with the slow speed.

In a fifth step O5 of the opening phase O, the signal S1 is still in the ON state and the signal S2 switches to the OFF state, the signal S3 remaining in the OFF state. The travel of the shutter then continues with the rapid speed.

In a sixth step O6 of the opening phase O, the signal S1 is still in the ON state. The maximum opening travel Cₘₐₓ of the shutter being reached, said shutter is blocked.

To engage the closing phase F, the signal S1 switches to the OFF state. The signal S2 switches to the ON state and the signal S3 remains in the OFF state, a slow closing speed is thus imposed during step F1.

In a second closing step F2, the signal S3 switches to the ON state and drives a blocking of the shutter, the signal S2 remaining in the ON state or switching to the OFF state.

In a third closing step F3, the signal S3 switches to the OFF state and the signal S2 switches to (or remains in) the ON state, thus driving a closing at slow speed.

It goes without saying that the examples that have been given are only particular illustrations in no way limiting as regards the opening-closing profiles of the shutter.

### REFERENCES

U.S. Pat. No. 6,294,122
EP 2 679 374
EP 2 918 289
U.S. Pat. No. 6,086,357
EP 1 196 274

1.-11. (canceled)

12. A system for controlling a shutter slidably arranged in a plastic material injection nozzle, comprising a rotary electric motor and a mechanism adapted to couple said motor to the shutter to slidably drive the shutter between a closing position of the nozzle and a maximum opening position of the nozzle, wherein the mechanism comprises:
an eccentric integral with an output shaft of the motor so as to be rotationally driven by said output shaft, comprising a crank pin parallel to the output shaft but non-coaxial with said shaft,
a slide adapted to be made integral with one end of the shutter, and
a connecting rod comprising a first end articulated on the crank pin of the eccentric and a second end articulated on an axis of the slide such that rotation of the eccentric causes sliding of the oscillating shutter between the closing position and the maximum opening position.

13. The system according to claim 12, wherein the axis of rotation of the output shaft of the electric motor is perpendicular to the sliding axis of the shutter.

14. The system according to claim 12, further comprising a guide wherein the slide is slidably arranged.

15. The system according to claim 12, wherein the end of the shutter comprises a radial collar and the slide comprises a slot adapted to receive said collar, said slot extending in a plane perpendicular to the sliding direction of the shutter.

16. The system according to claim 12, wherein the slide comprises a slot and a washer able to be displaced radially in said slot, and the end of the shutter is integral with said washer.

17. A plastic material injection system, comprising:
a distributor comprising at least one injection nozzle,
at least one shutter slidably mounted in the injection nozzle between a closing position of the nozzle and a maximum opening position of the nozzle,
a base plate comprising a housing wherein is arranged the system for controlling the shutter according to claim 12,
a electronic board for controlling the actuator, comprising at least two components among:
a component adapted to regulate the opening or the closing of the shutter at a first constant speed,
a component adapted to regulate the opening or the closing of the shutter at a second constant speed, greater than the first speed, and
a component adapted to selectively block the rotation of the motor,
a sequential control unit comprising at least two control paths configured to send selectively an electrical control signal to the electronic board via one of said control paths in such a way that:
under the effect of a first signal sent via a first control path, one of the components is activated, and
under the effect of a second signal sent via a second control path, another component is activated.

18. The system according to claim 17, wherein at least one of the actuator and the shutter is provided with a position sensor and the sequential control unit is configured to control the transmission of control signals as a function of measurements supplied by said position sensor.

19. The system according to claim 17, wherein the sequential control unit is configured to further take into account at least one of the following data: a time of the injection method, a position of a sensor, a pressure or a temperature in the injection tooling, and a signal of the injection moulding machine.

20. The system according to claim 17, wherein the sequential control unit is configured to send an electrical control signal in the form of a direct current.

21. The system according to claim 17, wherein the sequential control unit is configured to send an electrical control signal in the form of an alternating current.

22. A method for modifying a plastic material injection system, wherein said system comprises:
a distributor comprising at least one injection nozzle,
at least one shutter slidably mounted in the injection nozzle between a closing position of the nozzle and a maximum opening position of the nozzle, and
a base plate comprising a housing wherein is arranged a hydraulic or pneumatic cylinder for controlling the shutter,
the method comprising removing the hydraulic or pneumatic cylinder and replacing said hydraulic or pneumatic cylinder in the housing by a control system according to claim 12.
